(19) United States
(12) Patent Application Publication
(10) Pub. No.: US 2005/0275534 A1
(43) Pub. Date: Dec. 15, 2005

(54) Universal pager (locator) for small devices, ie cell phones, remote control (T.V.), keys

(76) Inventor: Fareedah Taliah Ameen, Lansing, MI (US)

Correspondence Address: F. Ta'Liah Ameen, 1426 Knollwood Ave., Lansing, MI, 48906, US

(21) Appl. No.: 10/867,317

(22) Filed: Jun. 15, 2004

(51) Int. Cl. G08B 1/08

(52) U.S. Cl. 340/539.32

(57) ABSTRACT

US Patent application for a universal paging device to locate small devices such as cell phones and remote control pagers. First model is designed to transmit and receive one paging signal. The second model is designed to locate two separate lost items. The device comes with the two items packaged together, (A) transmitter and (B) transceiver-separate pieces. The transmitting signaler—part A (stationary device, on the side of t.v. or wall) sends a signal to Part B (the receiving mechanism) which would be attached to the back of cell phone or remote control by adhesive and is designed to beep (receive the signal) as well as blinking red signal indicator light would come on until the device is found. The device would be battery operated with a 2 yr or 5 year battery.

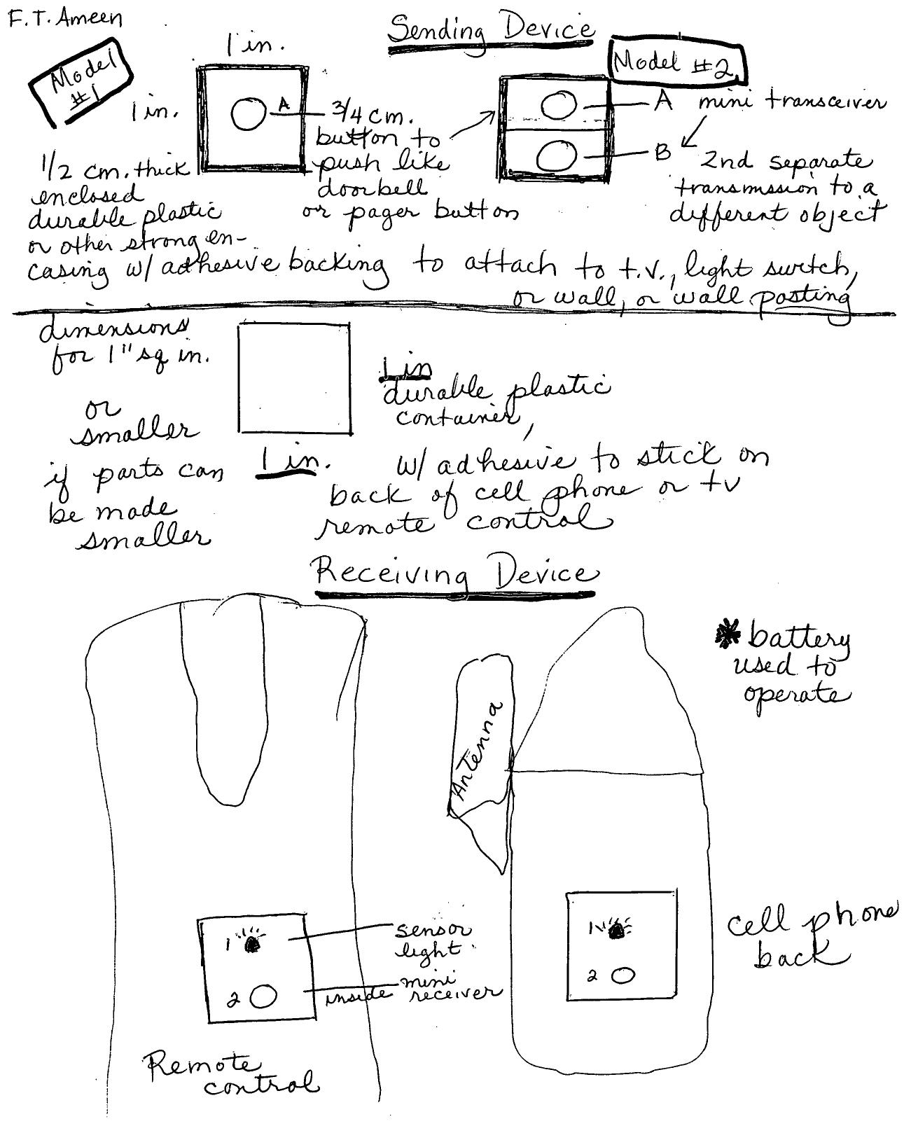

Plans for Utility Design Patent:

Suggested name: Universal pager (locator) for small devices, ie cell phones, remote control (T.V.), keys.

Purpose: To locate misplaced, lost items, within radius of home by using transceiver, paging type mechanisms to send the signal within the home to lost device which will beep until found.

[cell phone back, remote controller back] will have a receiving system that will beep as well as produce a red sensor indicator light (to be found).

Sending signal—(transceiver) will send signal from stationary location in home, ie side of T.V., light switch, or wall/wall post by pushing button to send signal to lost item (which has receiver on back).

Model #1:

Is designed to locate 1 lost item.

Model #2:

Is designed to locate 2 different lost items (of course 2 different receivers) inside.

1. This claims a use for cell phones and remote control devices and other small devices, that are lost to be located.

2. Already existing technology of paging devices will be used to locate small devices dependent on the first claim.

3. This claims an encased ‘receiving’ (R) and a separately encased ‘transmitting’ (T) device.

4. Two separate mechanisms, (R & T) as part of the same invention to be used together, ie. transmitting device and receiving device, dependent on the above claim.

5. Two models of the same invention permitting the location of one device (Model A) or locating of two lost devices (Model B), dependent on the above claim.

6. Use of adhesive materials to attach mechanisms (T) to wall, television, light switch, computer screen as well as to a the (R) cell phone, remote controller, key chain, etc. dependent on above.

7. This claims a button like mechanism on the transmitter to push to send the signal to the transceiver ( a blinking red light and beeping signal) on the transceiver.

8. Both mechanisms will have inside of them transmitting or receiving signalers, dependent on the above claim.

9. This button is an on/off mechanism that can be pushed to cut off the signal once the lost item is found, dependent on above claim.

10. A 2-5 yr. battery will be used in the devices dependent on the above claim.
